(19) United States
(12) Patent Application Publication
(10) Pub. No.: US 2012/0179711 A1
(43) Pub. Date: Jul. 12, 2012

(54) System and Method for Accessing a Database Including Data Abstraction Layer and Request Table Processing

(76) Inventors: Eric Delafortrie, Neerijse (BE); Ivan Mostien, Antwerpen (BE); Eefje Colman, Lierde (BE); Luc Quix, Mechelen (BE)

(21) Appl. No.: 13/345,658

(22) Filed: Jan. 6, 2012

Related U.S. Application Data
(60) Provisional application No. 61/430,538, filed on Jan. 6, 2011.

(51) Int. Cl. G06F 17/30

(52) U.S. Cl. 707/769; 707/792; 707/E17.014; 707/E17.055

(57) ABSTRACT

A method for processing changes to a database, the method including: receiving a request to alter data stored in the database, the request including data being entered in one or more steps wherein each of the steps displays one or more data fields associated with the step; generating a plurality of records based on the received request, wherein the records reflect a particular grouping of the data fields configured to abstract a data model used by the database; temporarily storing the plurality of records in a table; determining whether the request should be processed to alter the data stored in the database; and in response to the determination, modifying the data stored in the database in accordance with the plurality of records stored in the table.

### CROSS-REFERENCE TO RELATED APPLICATIONS

This non-provisional application claims the benefit of U.S. Provisional Patent Application No. 61/430,538, filed on Jan. 6, 2011, the entire disclosure of which is incorporated by reference herein.

This application is also related to U.S. Application entitled Human Resources Management System and Method Including Personnel Change Request Processing (attorney docket N405:68802), filed on even date herewith, the content of which is incorporated herein by reference.

### BACKGROUND

Computer databases are commonly used by companies to store and track information related to human resources (HR) management. Exemplary data that may be stored and tracked by a company include, for example, an employee's personal information, starting date, salary, attendance record, and the like. Such information can all be stored electronically in software systems provided by companies such as SAP® and Oracle®.

One drawback to existing human resource management systems is that the user interfaces provided by such systems very often mimic the database structure and do not reflect the logic of a HR business process that may require data to be grouped, presented and changed in a different way than the database structure suggests. What is therefore desired for a modern HR system is a way to present, change and group data differently than what the database structure suggests, in essence making abstraction of the database structure in order to present meaningful coherent data structures from a business logic perspective rather than from a database structure perspective.

### SUMMARY

Aspects of embodiments of the present invention are directed to a system and method for accessing a database through an abstraction layer and a temporary database. The system and method may provide an improved user interface to a database in which data can be created, updated, displayed, and deleted in a view that is more logical for a user rather than in a view that is associated with the manner in which the data is structured or stored in the underlying database. An abstraction layer supports this functionality by abstracting away the underlying data structures of the database and regrouping the data into “fieldsets” for use by the user interface.

Aspects of the present invention are also directed to a system and method for allowing multiple users to collaboratively contribute to changes to the database and save data in a temporary database (or “request table”) within the system without causing data to be written to main portions of the database (or “working database”) that are used for day to day operations. As such, consistency and atomicity of the system are improved because incomplete or proposed changes are only written to the working database when the changes are complete and/or approved.

Aspects of the present invention are directed to a human resources management system and method having an improved user interface in which the data presented to the user to be created, updated, displayed and deleted are presented in a business logic view different than, but integrated in, the underlying HR database system such that a user interacts with the database without any knowledge of database structures. According to one embodiment of the invention, the changes are made through a simple web-browser-based interface.

According to one embodiment of the present invention, multiple users can collaboratively contribute to changes to the database and save the data within the system without causing the data to be written to main portions of the HR database (also referred to as a “working database”), that are used for day-to-day operations. In this way, the consistency and atomicity of the system are improved because changes are only written to working database when the changes are either approved and/or completed.

According to one embodiment, the elements of consistency and atomicity are provided via an intermediate layer referred to as an abstraction layer that presents data according to a desired business logic, and stores the data in a temporary table (or “request table”) while being processed, approved, and completed.

One embodiment of the present invention is directed to method for processing changes to a database, the method including: receiving a request to alter data stored in the database, the request including data being entered in one or more steps wherein each of the steps displays one or more data fields associated with the step; generating a plurality of records based on the received request, wherein the records reflect a particular grouping of the data fields configured to abstract a data model used by the database; temporarily storing the plurality of records in a table; determining whether the request should be processed to alter the data stored in the database; and in response to the determination, modifying the data stored in the database in accordance with the plurality of records stored in the table.

The may be grouped into a data set, the data fields of the data set corresponding to data fields in one or more data structures in the database.

The generating the plurality of records may include generating a field record for each of the data fields in the data set.

The request may be identified by a request ID, and each field record includes the request ID of the corresponding request.

The generating the plurality of records may include generating a data structure record for each of the one or more data structures in the database including a data field corresponding to the data field in the data set.

The data structure record may identify the data structure in the database affected by the received request.

The generating the plurality of records may include generating a log record identifying a user action with respect to the received request.

Each step may display the one or more of the data fields associated with the step, on a single screen.

According to another embodiment of the present invention, database system includes: a user interface system; a process integration layer; a temporary database; and a working database, the process integration layer being configured to: receive a request to alter data stored in the working database via the user interface system, the request including data being entered in one or more steps wherein the user interface system is configured to display, in each of the steps, one or more data fields associated with the step; generate a plurality of records based on the received data, wherein the records reflect a particular grouping of the data fields configured to abstract a data model used by the working database; temporarily store the plurality of records in the temporary database; determine whether the received data should be processed to alter the data stored in the working database; and in response to the determination, modify the data stored in the working database in accordance with the plurality of records stored in the temporary database.

The user interface system may be a web-based user interface.

The temporary database and the working database may be tables within a single database system.

The data fields may be grouped into a data set, the data fields of the data set corresponding to data fields in one or more data structures in the database.

The data fields may be grouped into a data set, the data fields of the data set corresponding to data fields in one or more data structures in the database.

The request may be identified by a request ID, and each field record may include the request ID of the corresponding request.

The process integration layer may be configured to generate the plurality of records by generating a data structure record for each of the one or more data structures in the database including a data field corresponding to the data field in the data set.

The data structure record may identify the data structure in the affected by the received data.

The process integration layer may be configured to generate a log record identifying a user action with respect to the received data.

The user interface may be configured to display the one or more of the data fields associated with the step, on a single screen.

According to another embodiment of the present invention, a method for managing a database system includes: receiving a user request for effectuating a change in a working database, the working database including a plurality of data structures having a plurality of data fields, wherein the plurality of data fields are grouped into a data set linked to a user input step; identifying the user input step based on the request; displaying each of the data fields of the data set during the user input step for prompting input of data associated with one or more of the data fields; generating a plurality of records based on the data input during the input step; temporarily storing the plurality of records in a table; determining whether the change in the working database should be effectuated; and in response to the determination, effectuating the change in the working database in accordance with the plurality of records stored in the table.

### BRIEF DESCRIPTION OF THE DRAWINGS

The accompanying drawings, together with the specification, illustrate exemplary embodiments of the present invention, and, together with the description, serve to explain the principles of the present invention.

FIG. 1A is a schematic block diagram of a human resource management system according to one embodiment of the invention.

FIG. 1B is a functional block diagram illustrating a human resource management workspace according to one embodiment of the invention.

FIG. 1C is a schematic diagram illustrating the relationship between data objects of an underlying database and a human resource management workspace according to one embodiment of the present invention.

FIG. 1D is a screenshot from a user interface of the workspace displaying a fieldset according to one embodiment of the present invention.

FIG. 2A is a process flow diagram illustrating a method of defining a fieldset according to one embodiment of the present invention.

FIG. 2B includes four exemplary screenshots illustrating the definition of a fieldset and its associated fields and its appearance in an end user interface according to one embodiment of the present invention.

FIG. 2C is an illustration of the data models used for fieldsets and personal data changes according to one embodiment of the present invention.

FIG. 3 is an illustration of a relationship between a default or main data type of a fieldset and the other data types of that fieldset according to one embodiment of the present invention.

FIG. 4 is a screenshot of a language translation toolbar according to one embodiment of the present invention.

FIGS. 5A and 5B are screenshots of a field in a display mode and an update mode, respectively, according to one embodiment of the present invention.

FIGS. 5C and 5D are screenshots of a field in a display mode and an update mode, respectively, according to one embodiment of the present invention.

FIG. 5E is a screenshot of a field having a display dependency, according to one embodiment of the present invention.

FIG. 5F is a screenshot of fields listed in a default mode, according to one embodiment of the present invention.

FIG. 5G includes two screenshots of the display of a fieldset in which secondary fields are hidden in the left screenshot and shown in the right screenshot, according to one embodiment of the present invention.

FIG. 5H is a screenshot of a screen built with a fieldset in table mode and in which fields are grouped, according to one embodiment of the present invention.

FIGS. 5I and 5J are screenshots showing the configuration of COMP_GRP and COMP fields in accordance with an embodiment of the present invention.

FIG. 5K is a screenshot showing three groups (with labels) according to one embodiment of the present invention.

FIG. 5L is a screenshot illustrating an example from an Absence Maintenance interface according to one embodiment of the present invention.

FIG. 6 is an illustration of the data model used for a request table according to one embodiment of the present invention.

FIG. 7 is a process flow diagram illustrating a method of processing a request from a user according to one embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Aspects of embodiments of the present invention are directed to a system and method for accessing a database through an abstraction layer and a temporary database. The system and method may provide an improved user interface to a database in which data can be created, updated, displayed, and deleted in a view that is more logical for a user rather than in a view that is associated with the manner in which the data is structured or stored in the underlying database. An abstraction layer supports this functionality by abstracting away the underlying data structures of the database and regrouping the data into “fieldsets” for use by the user interface.

Aspects of the present invention are also directed to a system and method for allowing multiple users to collaboratively contribute to changes to the database and save data in a temporary database (or “request table”) within the system without causing data to be written to main portions of the database (or “working database”) that are used for day to day operations. As such, consistency and atomicity of the system are improved because incomplete or proposed changes are only written to the working database when the changes are complete and/or approved.

In general terms, embodiments of the present invention are directed to a human resources management system coupled to a human resource database. The system includes an abstraction layer (implemented, for example, via software) for abstracting a database structure of the human resource database. Data to and from the human resources database flows through the abstraction layer so that data from the database may be presented to a user from a business logic perspective that may be different from a database structure perspective.

According to one embodiment, the abstraction layer is configured to group various data fields used by the data structures of the human resource database into one or more data sets, referred to as fieldsets. Each data set may be associated with a particular HR concept. For example, data fields such as street name, city name, country name, and postal code which may not be grouped together in the underlying human resource database may, via the abstraction layer, be grouped together into a data set representing the concept of an address. The fields of the particular data set may then be viewed and manipulated in a logical manner. The abstraction of data fields into a logical data set allows users to view, create, delete, modify, and otherwise interact with the database without knowledge of the specific data model that is used by the database.

According to one embodiment of the present invention, multiple users may collaboratively contribute to changes of a human resource database. According to one embodiment, the change is processed via a request submitted by a particular user, such as for example, a personnel change request, described in further detail in the above-referenced application entitled Human Resources Management System and Method Including Personnel Change Request Processing. As described in the above-referenced application, one or more wizard steps guide a user in making a change to the human resource database. Each request is associated with at least one fieldset that groups the fields that may be changed via the request and information provided in an earlier wizard step may influence what information is requested from the user in a later wizard step. One or more wizard steps may guide a user in making changes to the fields in the fieldset. In this regard, each wizard step may display one or more fields of the fieldset on a single screen, and prompt a user to enter data for the displayed fields in that wizard step.

As changes are processed, approved, and completed, the changes are temporarily stored in a temporary table (or “request table”). Once the system detects a condition indicating that the changes may be transferred to the human resource database, the system identifies the particular data structures of the human resource database that are mapped to the changed fields, and proceeds to modify the identified data structures accordingly.

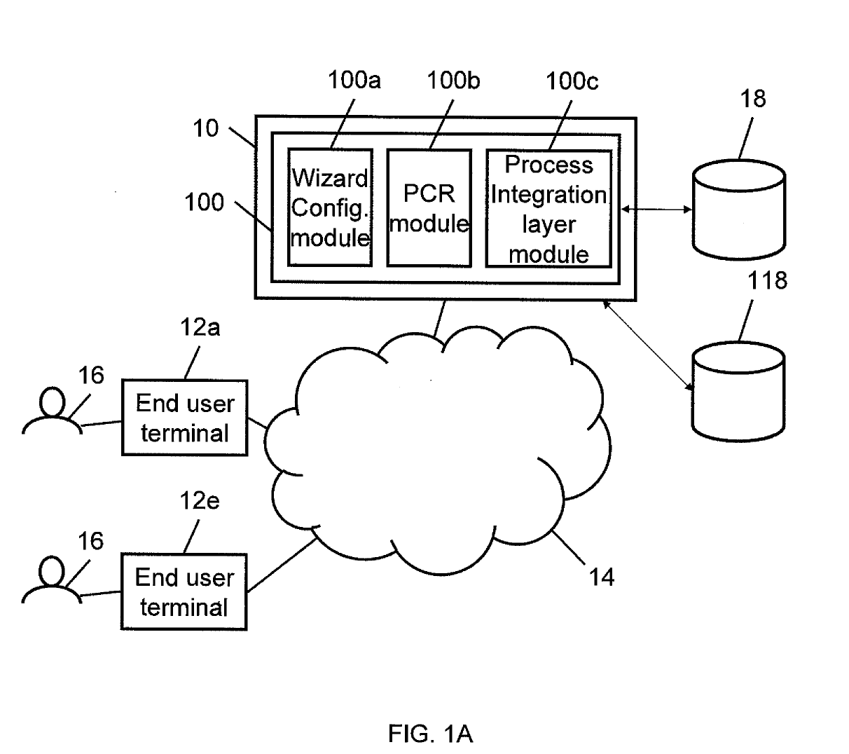

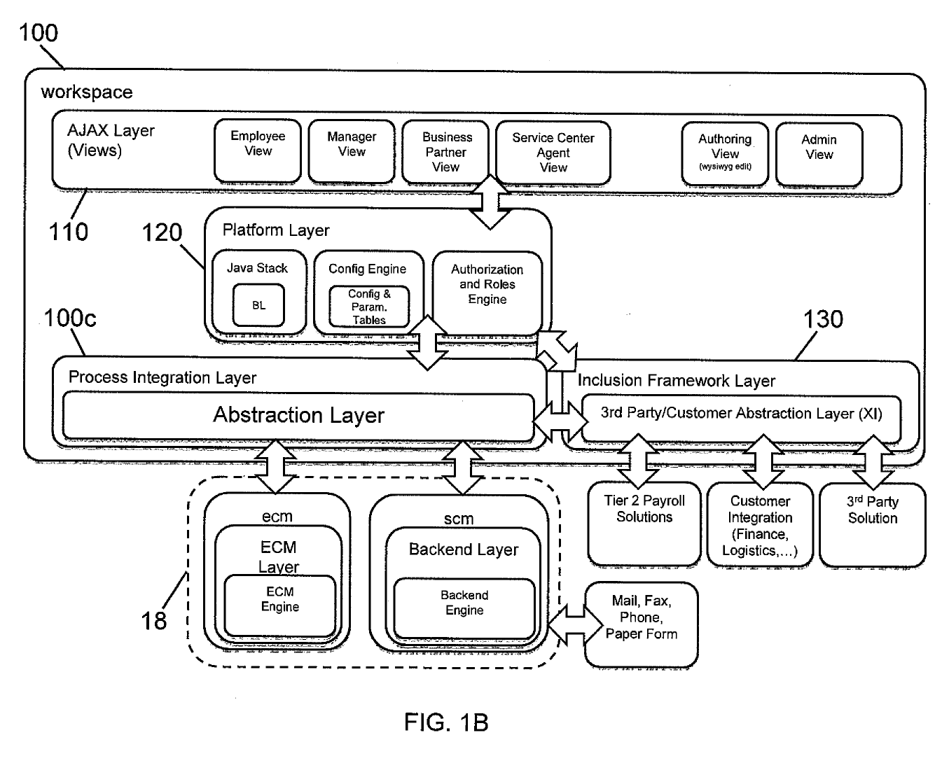

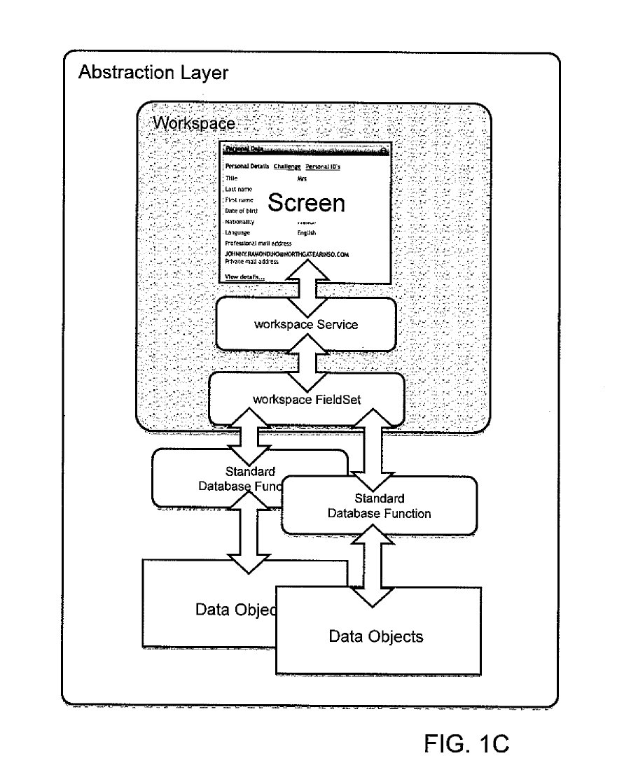

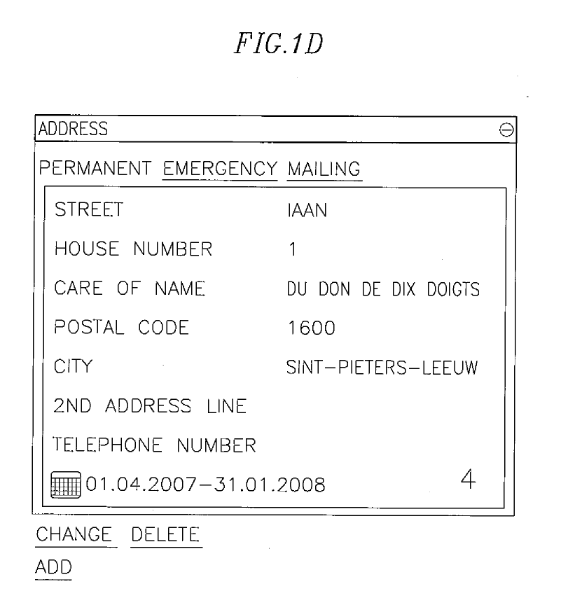

FIG. 1A is a schematic block diagram of an HR management system according to one embodiment of the invention. The system includes a server 10 coupled to various end user terminals 12a-12e (collectively referred to as 12) over a data communications network 14 such as, for example, a public Internet, a local area network, or a virtual private network. The users (or actors) 16 may include employees, managers, HR professionals, service customer agents, non-employee personal, and other people associated with an organization.

The server 10 is also coupled to one or more database servers 18. The database server 18 includes a processor, a memory, a persistent data store (or mass storage device, e.g., a disk drive or drive array), and a communications device. Computer software modules stored in the memory implement database features in the database server, which allow data to be written to and read from the persistent data store. Software modules capable of implementing such features include packages from SAP®, Oracle®, PostgreSQL®, and others. The database server 18 may also include a plurality of servers working together or may be running on the server 10 in a virtualized machine or directly on the server 10.

The server 10 also includes one or more software modules for providing various services to the end terminals. Such software modules may include a wizard configuration module 100a for allowing the end users 16 to configure the server 10 via the end user devices 12, a Personnel Change Request (PCR) module 100b for allowing the end users 16 to submit and process requests, and a process integration layer module (or “abstraction layer”) 100c for managing the interactions between the wizard configuration module 100a, the PCR module 100b, and the database server 18. The personnel change requests (PCRs) are described in further detail in “Human Resources Management System And Method Including Personnel Change Request Processing”, filed on even date herewith, the content of which is incorporated herein by reference. The software modules 100a, 100b, and 100c running on the server 10 may be collectively referred to as a workspace 100. The workspace may also include other software modules, which will be apparent to a person of skill in the art. Although the various modules are described as computer program instructions which are stored in memory and executed by one or more processors hosted by the server 10, a person of skill in the art should appreciate that the modules may also be implemented via hardware, firmware (e.g. ASIC), or a combination of hardware, firmware, and software.

The server 10 is also coupled to a persistent data store (or mass storage device) 118, for storing information used by the server 10 for providing the various services. For example, the persistent data store may store server configuration information and user customizations, messages sent between users, saved drafts of requests (or transactions), pending requests, and the like.

According to one embodiment of the invention, the end user devices 12 and/or the servers 10 and 18 may connect to the data communications network 14 using a telephone connection, satellite connection, cable connection, radio frequency communication (e.g., cellular data communication), or any wired or wireless data communication mechanism known in the art. To this end, the devices may take the form of a personal computer (PC), hand-held personal computer (HPC), television and set-top-box combination, personal digital assistant (PDA), smartphone, or any consumer electronics device known in the art.

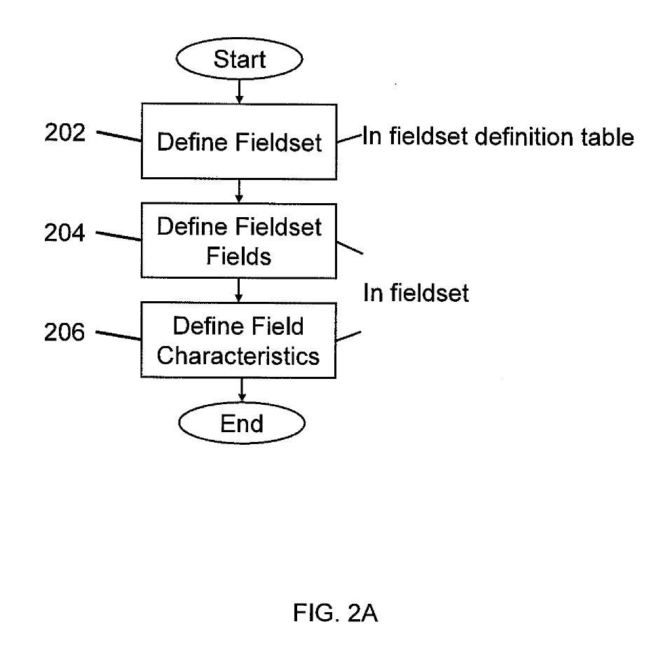

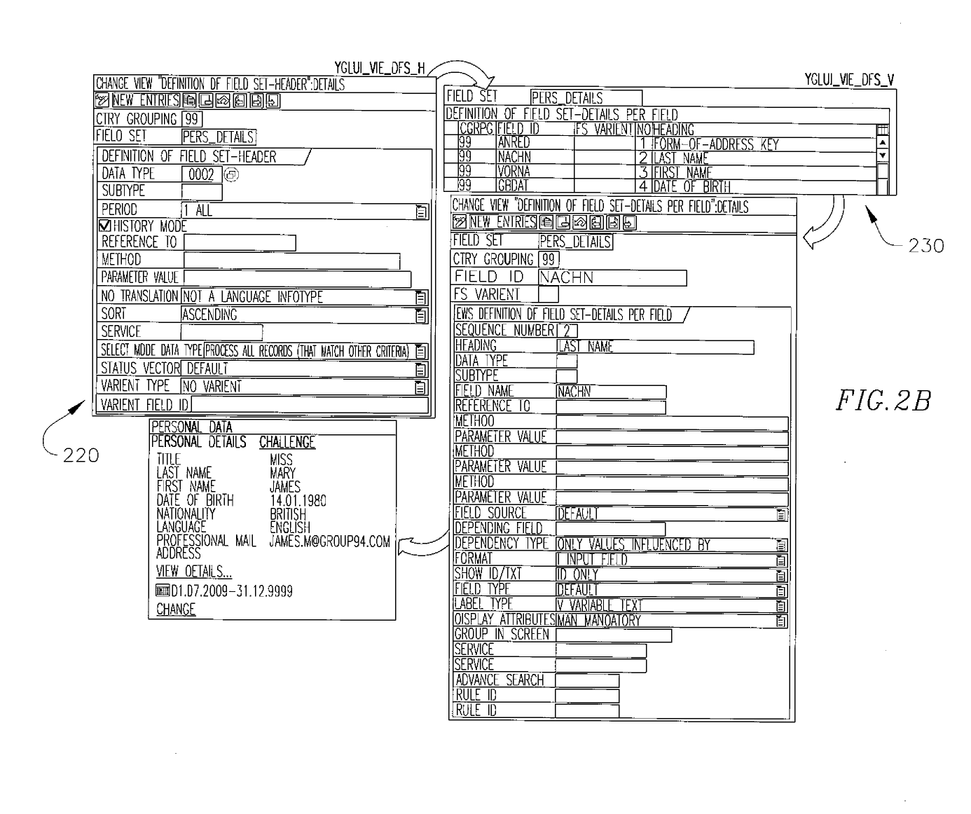

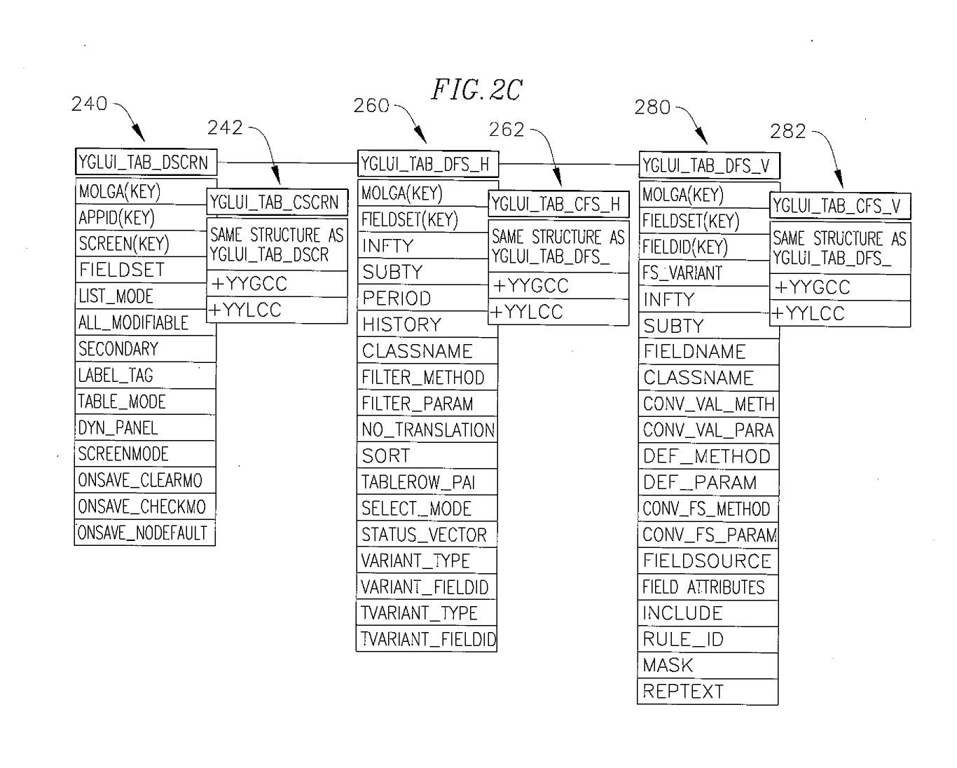

According to one embodiment, every action executed in the workspace accesses data stored in the database 18 through the abstraction layer (or process integration layer module) 100c. According to one embodiment, the abstraction layer 100c provides access to fieldsets 230, which may be defined in accordance with a fieldset definition table 220 (see, e.g., FIG. 2B). According to one embodiment, the fieldset 230 includes a series of parameters and programs that allow a user to visualize data from the database 18 in a different grouping or format than the actual database structures. The abstraction layer also includes a temporary table, referred to as a request table, configured to hold data temporarily while being in the execution of an action (e.g., a PCR) or a data change which the action or data change is pending completion by the same user or a different user, or approval by a different user. The data associated with the action or data change is moved from the temporary storage in the request table to the database 18 on completion and/or approval of the data changes, committing any changes to the database in the according database structures. According to one embodiment, while executing an action, the workspace 100 simulates the saving of the data in the actual database 18 to ensure consistency and validity of the data without actually storing the data in the database 18.

The abstraction layer and request table allow the workspace 100 to temporarily save changes (which the users may enter during one or more sessions and in which the partially changes can be passed between users without writing to the underlying database 18), thereby improving the concurrency of access and the consistency of the database 18. According to one embodiment, the workspace 100 temporarily saves all changes, either from a PDC (Personal Data Change) or a PCR (Personnel Change Request), in a commonly accessible location (e.g., a central location on a server) such as in the request table stored in the database 18 running on the database server. The request table may also be stored in a separate database system running on the same server (e.g., server 10) that the data abstraction layer module, PDC, and PCR module are running on, or stored in other persistent data stores.

In addition, the term “commonly accessible” is used to indicate that the data is stored in a location that is accessible by any user 16 having sufficient permissions from any end user terminal 12, and not that any user 16 may have access to it. In general, a user 16 may have access to the data stored in the system if sufficient permissions are granted to that user by the system.

FIG. 1B is a functional block diagram illustrating a human resource management workspace according to one embodiment of the invention. The human resource management workspace 100 includes a process integration layer (or abstraction layer) 100c to provide access to fieldsets stored in a database system 18. The workspace 100 also includes a user interface layer 110, which is shown in FIG. 1B as a web browser based “AJAX Layer”. The user interface layer may present different views to users based on authorizations or roles associated with those users. The management of authorization and roles may be managed by an authorization and roles engine within a platform layer 120 of the workspace 100, the platform layer 120 being configured to control business logic and the processing of fieldsets assembled by the abstraction layer 100c. In some embodiments of the present invention, the workspace 100 includes an inclusion framework layer 130 providing an application programming interface (API) or interface for connecting to 3rd party or other customer software systems.

The database 18 may include modules for storing and managing information related to various aspects of human resources. For example, FIG. 1B depicts “ecm” and “scm” modules of the database 18 for managing and processing requests related to enterprise content management and, service center management. Other modules may be related to managing personal data related to the users, benefits, timecards, performance reviews, etc. These modules may be implemented in a variety of software platform such as Microsoft™ .NET™.

According to one embodiment, the abstraction layer 100c configures one or more fieldsets. FIGS. 1C and 1D illustrate the relationship between fields of a fieldset and the actual underlying database structures according to one embodiment of the present invention. Data in the database 18 is generally stored in a plurality of fields having names. One or more data fields may be collected together to represent one data object. These data fields (known, for example, in the SAP™ database system as “data types”) are used to define data objects as shown in FIG. 1C. For example, as shown in FIG. 1D, “street number,” “street,” “city,” “country,” and “postal code” fields may be collected together as an “address” object. Various other data types, such as a personal details object (collecting, e.g., “name,” “birthdate,” “gender,” “marital status,” etc.) also exist in the database 18.

According to one embodiment, in order to provide a more logical view of the data in the database 18, data objects of different data types can be collected together into fieldsets and accessed through the workspace 100. For example, an employee fieldset may include a personal details object (as described above), along with two address objects (one for home and one for work). Thus, a fieldset may group data fields of multiple data structures utilized by the human resources database.

FIG. 2A is a process flow diagram executed by a fieldset configuration module of the workspace 100 for configuring a fieldset according to one embodiment of the invention. The sequence of steps of the process is not fixed, but can be altered into any desired sequence as recognized by a person of skill in the art. Steps in the process flow diagram shown in FIG. 2A will be described in conjunction with the screenshot of FIG. 2B and the data model shown in FIG. 2C.

A Fieldset ID is a unique identifier of a workspace definition of the content of a screen and is defined during step 202 of FIG. 2A in a fieldset definition table 220 (e.g., YGLUI_VIE_DFS_H, as shown in FIG. 2B), which is used as the global table of fieldsets.

According to one embodiment of the present invention, the fieldset definition table (e.g., YGLUI_VIE_DFS_H) contains following fields, which will be described in more detail below:

Fieldset Id: unique identifier

Data type & Subtype: Main data type and subtype of the fieldset

Period: Dates to read the values

History mode flag: to identify whether to keep a log of every change

Reference to, Method and parameter value: Filter data options

No translation flag: to identify whether to maintain translations in the main data type

Sort: to define sorting order

Service: Alternative Fieldset strategy

Select mode data type

Status Vector: for PD data types

Variant type and Variant Field Id: Fieldset variant to have different fieldsets per record

Workspace fieldsets allow reading, display and maintaining data for different data types at once. In the fieldset header table, only the main data type needs to be indicated. The main data type is used to determine which data will be read (e.g., read by default). In the example of FIG. 2B, the personnel details fieldset PERS_DETAILS has data type 0002 as its main data type and includes a mix of data types including personal ID information of a person (e.g., data type “0002” fields) and e-mail address, user ID, and old legacy number fields (e.g., data type fields “0105” fields).

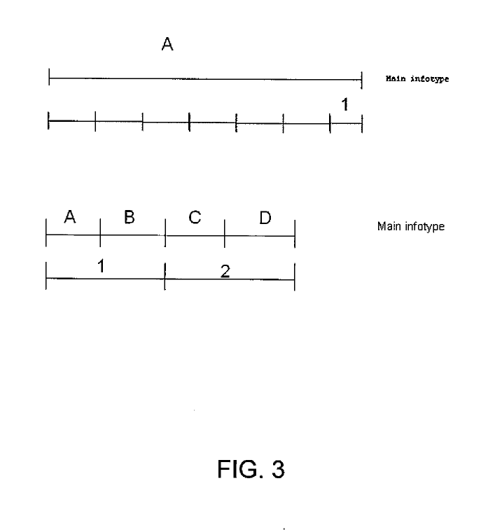

Referring to FIG. 3, in case the Period ‘All’ is indicated and we consider a number of records as visualized below, the fieldset will return one record A1 in the first case (FIG. 3, above) and 4 records A1, B1, C2 and D2 in the second case (FIG. 3, below).

In case data type 0105 would have been the main data type, the fieldset would return 7 records in the first case and 2 records in the second case, as illustrated in FIG. 3.

The subtype can be a particular subtype or a wildcard (‘*’). In case the subtype is indicated with the wildcard subtype *, all records from all subtypes for the main data type will be read.

The data type can be an data type (standard or custom) present in the database backend. The reading of the records is handled by the workspace strategies listed in a data type reading strategy table (e.g., YGLUI_CLA_T_PA_INFTY or YGLUI_CLA_T_PD_INFTY) based on the indicated main data type.

According to embodiments of the present invention, the “period” field may be used to specify a period for which records will be retrieved. By default, records for the main data type/subtype valid as from the system date will be retrieved. Through configuration, the reading period can be changed.

According to one embodiment of the present invention, values for the “period” field can represent periods of time in accordance with a period definition table (e.g., YGLUI_DOM_IFWK_PERIOD) as shown below in Table 1:

TABLE 1
Period definition table

| Value | date range |
|---|---|
| 1 | All |
| 2 | To current date |
| 3 | Current Year |
| 4 | Next Year |
| 5 | Current Payroll Period |
| 6 | Next Current Payroll Period |
| 7 | Today |
| 8 | Current Period |
| 9 | Current Week |
| 10 | Current Month |
| 11 | Last Week |
| 12 | Last Month |
| 13 | Last Month |
| 99 | Specified by user |

According to one embodiment, a workspace history mode is used when there are possibly multiple records that can be read based on the fieldset definition and that should be visible in a timeline mode instead of a list mode. In one embodiment, in a case where there are multiple records and the history mode is not switched on and the screen is not in list mode, then the screen content will not be loaded. List mode may be configured on the screen level and will be explained in more detail later.

The Select Mode field may be used to identify how one single record should be selected when one or several records have been read.

When reading an data type, a key (e.g., a field) may be used to filter out some of the records in the database. For example, Begin date and End date values can be used as a validity period for selection—that is, all records that fall within with the validity period are selected.

The Select Mode can be used to select one of the records retrieved when reading the data type. It only selects the records based on the validity of the data type records such as Begin Date & End Date. For instance, one could select only the last valid record.

Table 2 below illustrates a select mode value definition table which defines possible values and effect on selection behavior for the Select Mode field according to one embodiment of the present invention:

TABLE 2
Select Mode values definition table

| Value | Selection behavior |
|---|---|
| Blank | Process all records (that match other criteria) |
| 0 | Last Record That Intersects Selection Period |
| 1 | First Record That Intersects Selection Period |
| 2 | Record That Contains End of Selection Period |
| 3 | Record That Contains Start of Selection Period |
| 4 | Record with Exact Key provided |

For example, setting Select Mode to 0 selects the last record.

Table 3 below shows a list of one or more statuses (e.g., “1” for active, “2” planned, and so on) for personnel details data types, which allows the determination of which records status should be kept.

This is not exactly the same as a filter. For example, status vector “2-1” returns records of status 2 if they exist or record of status 1 if no planned version can be found. It means for a given key string, it only returns one record.

TABLE 3
Status values definition table

| Blank | Default |
|---|---|
| 0 | All record (no status vector) |
| 1 | Only Active Records |
| 2 | Only Planned Records |
| 4 | Only Approved Records |
| 21 | Planned records or active (2-1) |
| 54321 | Any pending records or active (5-4-3-2-1) |

After reading the records based on the main data type and period, a filter method, if configured, may be called when processing the records.

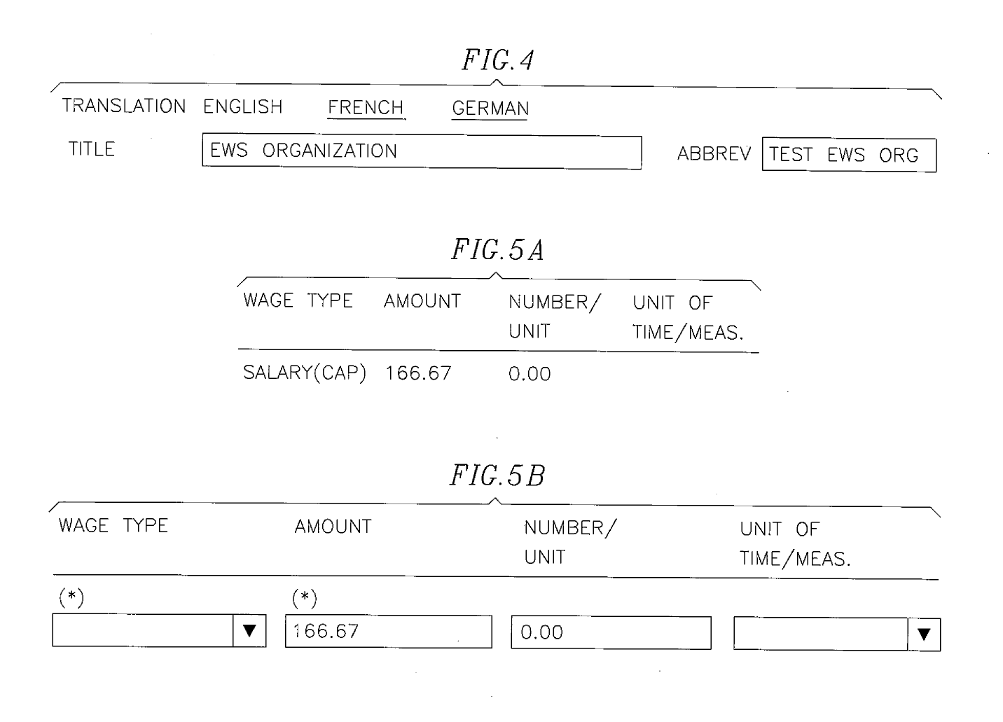

The translation flag in combination with a ‘TRANSLATION’ fieldid will ensure a translation bar is visible in the screen and the records are grouped per language. Display and maintenance of object translation is possible with these settings. FIG. 4 is a screenshot illustrating a translation bar displayed on the screen according to one embodiment of the present invention.

The sort field allows for sorting the records, e.g., Ascending: From low date to high date and Descending: From high date to low date

The Service field defines a PAI service on a table part row.

Fieldset Variants allows the specification that a fieldset variant is used, how the variant is calculated and what the field is to trigger the variant calculation.

FieldSet Variant Types include: ‘F’ for simple field values in which no service needs to be called in backend. The value of the field is the FieldSet Variant. ‘S’ means service get_fsvar_val is called when the FS Variant Field is changed. Space (or null) means no FS Variant is used for the Fieldset

FieldSet Field is a field for directly or indirectly influencing the value to put in FS Variant.

The Field ID is the unique identifier of the workspace definition of the fields of a fieldset and is defined in table defined in the global fieldset table (e.g., YGLUI_VIE_DFS_D), which is the global table of fields in fieldsets and contains following fields, which are described in more detail below. These fields and their characteristics are defined during steps 204 and 206, respectively, as shown in FIG. 2A.

Field Id: unique identifier

Field name: a field name e.g., an backend field name

Class, Methods and Parameter value: Value conversion, Defaulting and Fieldset conversion

Field source: data type db, Request db, Table part, PD data field 1001 data type and Send Document

Depending field and Dependency type: Field is aligned with the depending field and/or values are influenced

Format: Input field, Autocompleter, Checkbox, etc.,

Show ID/Text: Show ID, ID and Text, only text

Field type: Header or Secondary, Grouping

Label: workspace label

Display attributes: Mandatory, Hidden, etc.,

Group in screen flag

Service: Possible field values

Service: Process After Input (PAI)

Advanced search: link advanced search to the field

Rule Id: Regular Expression

Rule Id: Mask

Fieldset provides the name of the fieldset to which the field belongs. This fieldset should first be defined in the Fieldset header table.

Fieldid is a unique id to represent the field within the fieldset. This does not need to be the technical fieldname—a more descriptive name can be used instead.

This field is just the identifier. The Field name field represents the technical fieldname.

In one embodiment, in case a fieldset has 2 fields with fieldid ‘BEGDA’ and fieldid ‘ENDDA’, the fields are shown in a particular way in display mode: <icon> begda-value <dash> endda-value

This doesn't take sequence number and label type into account in display mode. Swapping to update mode will treat the fields as any other field taking sequence number and label type into account

In one embodiment, a fieldid ‘TRANSLATION’ is used in combination with the ‘Translation’ flag on fieldset level in order to show a translation bar at the top of a screen. The fieldname should be LANGU.

Fieldname contains the technical fieldname of the PA/PD field. In one embodiment, in the case of workspace fields (not belonging to any data type) the fieldname can be anything as long as the additional logic can recognize it.

According to embodiments of the present invention, classes, methods and parameters may also be implemented in the fieldsets.

In one embodiment, on fieldlevel 3 kinds of Process Before Output (PBO) operations can be defined. The logic of those PBO's should be implemented in the methods part of the class indicated in the corresponding configuration field. The classname at its core level may have the following naming convention: YGL<area>_CLA_CONV_<inftype>, where all PBO methods related to fields of data type <data type> are bundled.

According to one embodiment, the conversion method may have a fixed interface as defined in the conversion method interface definition table Table 4 below:

TABLE 4
conversion method interface definition table

| | | Pass by | | Typing | |
|---|---|---|---|---|---|
| Parameter | Type | value | Optional? | Method | Associated type |
| R_INFTY | Importing | | | Type | YGLUI_CLA_T_INFTY |
| | | | | Ref | |
| FLD | Importing | | | Type | YGLUI_TAB_CFS_V |
| IM_REQID | Importing | | X | Type | YGLUI_DAT_IFWK_REQ_ID |
| EX_RVAL | Exporting | | | Type | STRINGVAL |
| EX_RTEXT | Exporting | | | Type | STRINGVAL |

R_INFTY contains an instance of the data type record that is currently read and processed.

FLD is the fieldid for which the processing needs to be done.

IM_REQID can contain a request id in case the record is read from the workspace temporary tables instead from the PA/PD database.

EX_RVAL returns a value and text for the indicated field.

EX_RTEXT allows changing the value and/or text read from the temporary table or DB based on some specific logic.

Defaulting method: This method has the same interface as above and allows returning a value and/or text to present to the user when creating a new record. This is used to provide default fields for new records.

In some embodiments fieldset classes provide default values. For example, the USE_TODAY method provides default dates in the YGLUI_CLA_T_FIELDSET class.

Fieldset Conversion method: This method has R_INFTY and FLD as importing parameters and ch_settings and allows changing all field settings from the configuration before sending the information to the user web browser for display.

Field settings that can be changed may be defined or listed in a field settings table such as YGLUI_STR_WID_FS_FIELD.

In one embodiment, the user web browser only receives 1 field setting per screen. This field setting will be applied on all records currently processed for that screen.

A parameter can be configured on a per-method basis. This parameter can be accessed in the method implementation.

Field source: By default, the field source is set to ‘default’ and is mainly used in the PA/PD data type strategies to read the customized field in a certain way as shown in a field source definition table (e.g., YGLUI_DOM_SOURCE) as shown, for example, in Table 5. The Table Part value is also used to visualize the data in a certain way.

TABLE 5
Values from field source definition table:

| | Default |
|---|---|
| A | Adata field (1001) |
| T | Table Part |
| Q | Request fields |
| G | Generic Part |

The Table Part value is used for fields that are part of a table data type such as ‘wage type’ and ‘amount’ from data type 0008.

Fields indicated with this source are shown in tabular way both in display and update mode.

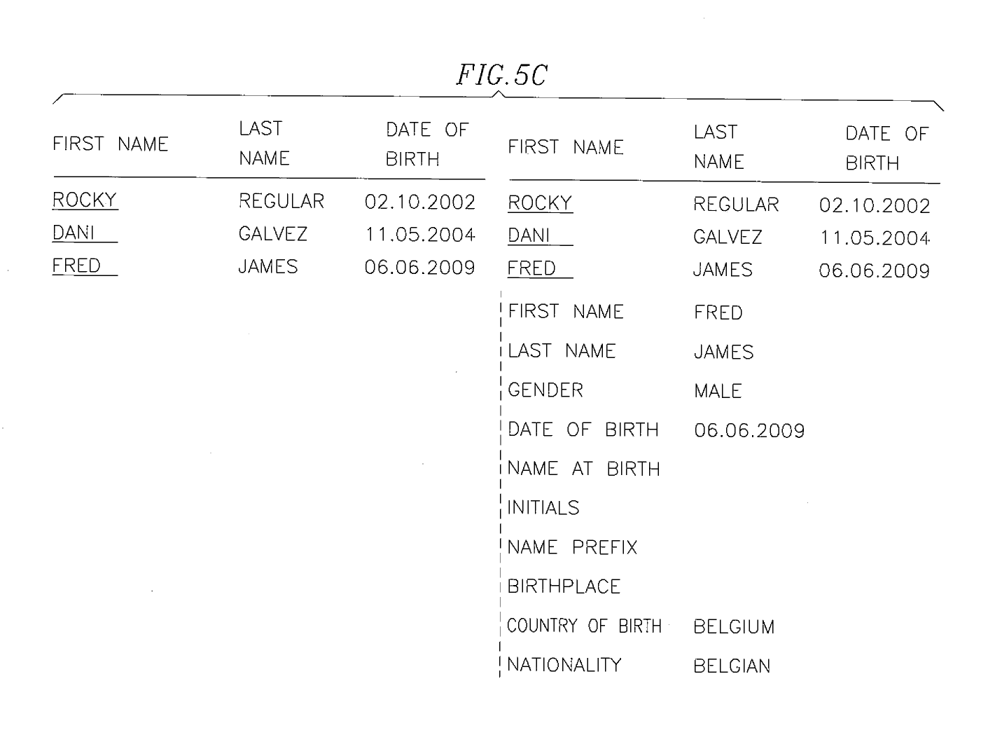

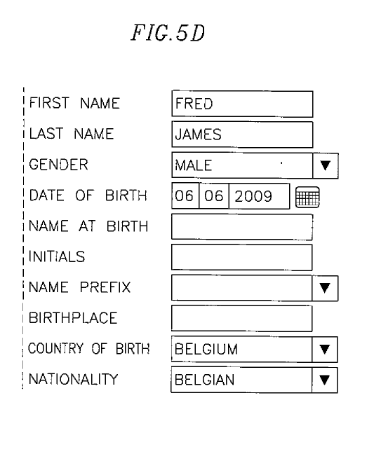

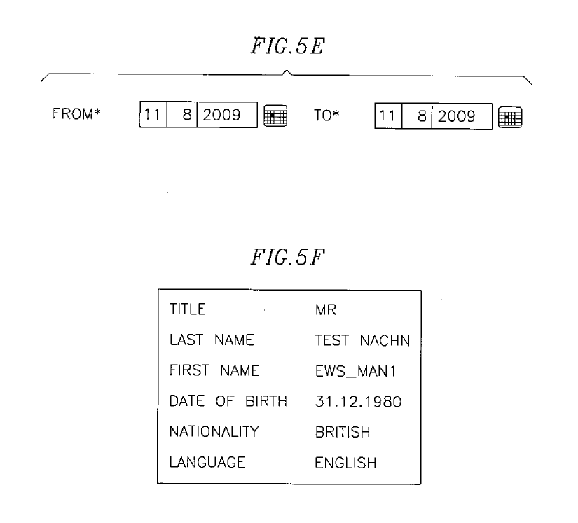

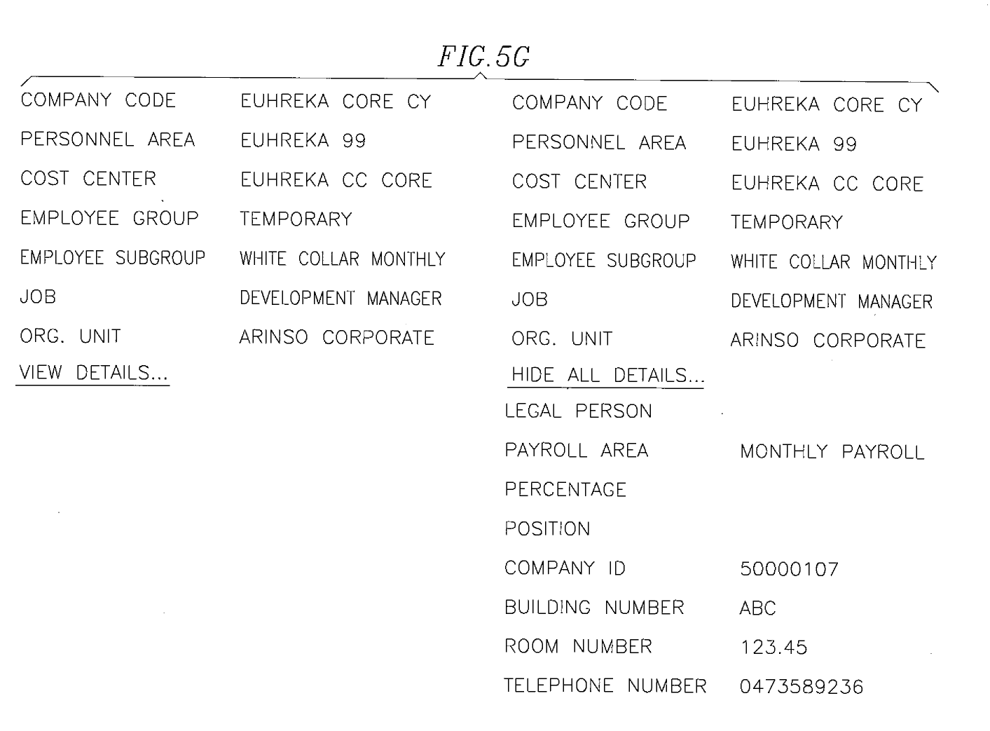

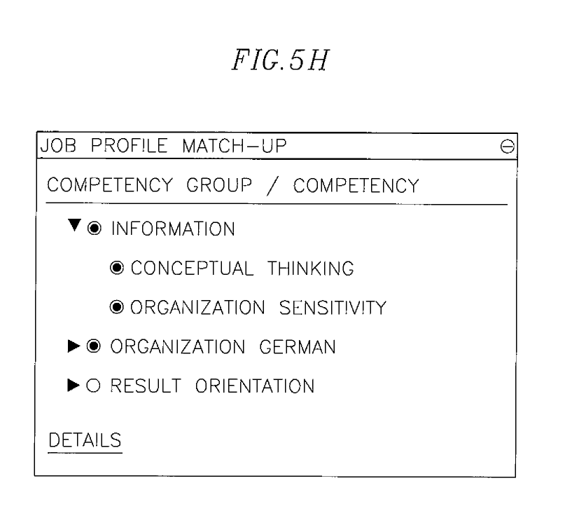

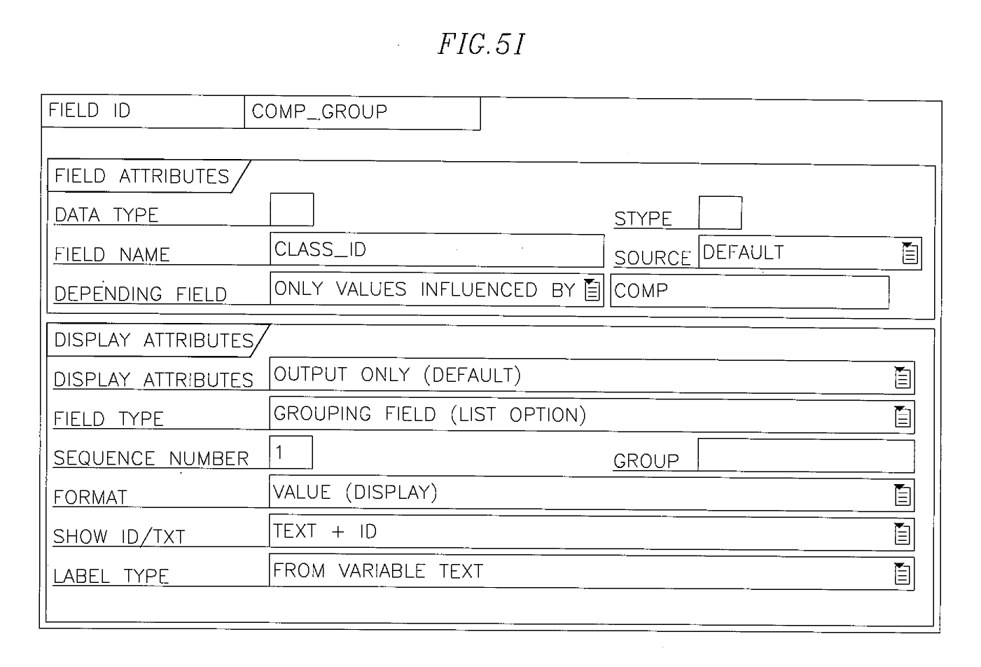

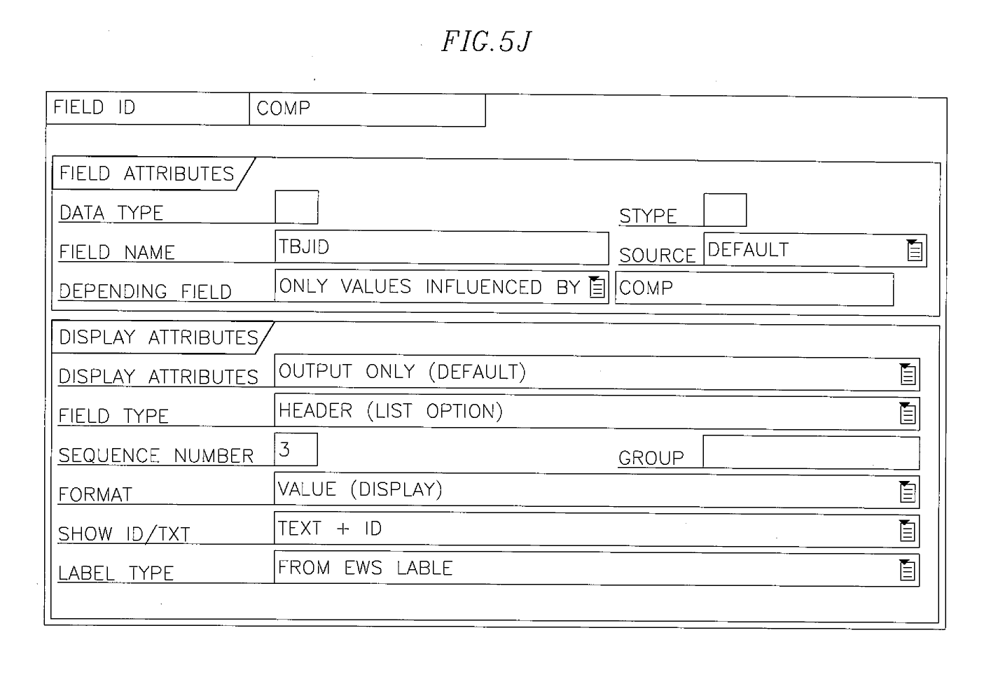

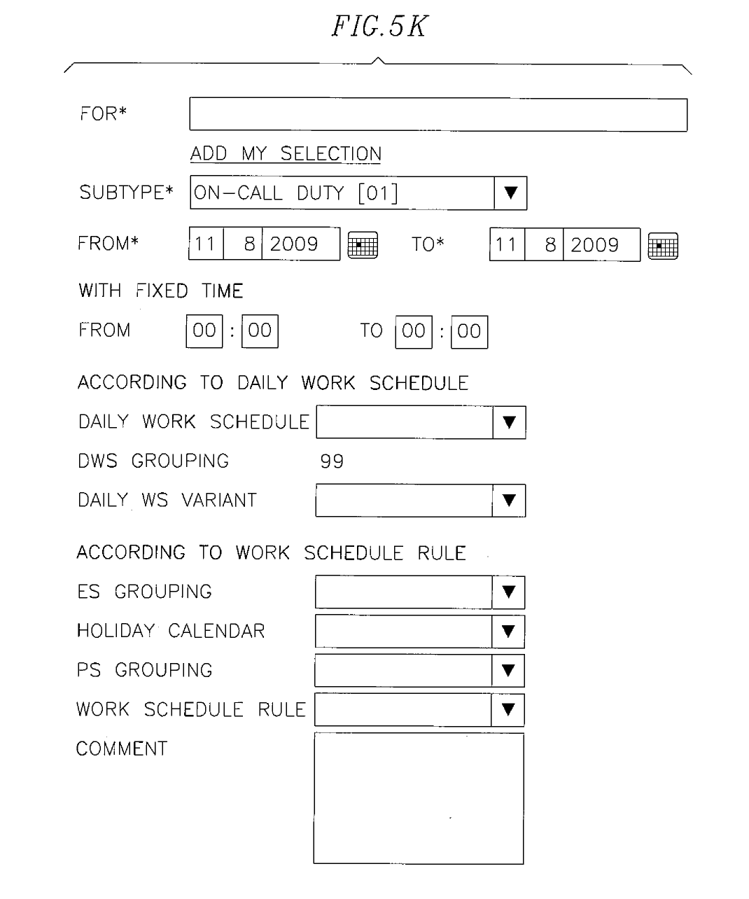

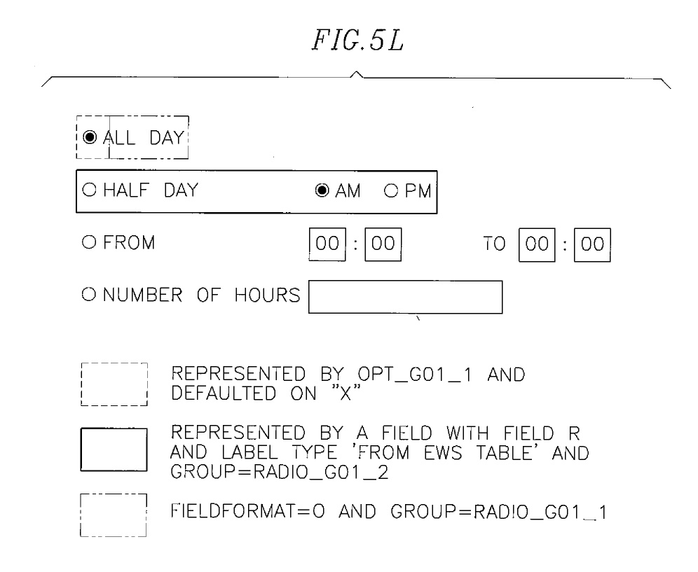

The Display mode and Update mode flags can be used to control whether the selected fieldset should be displayed as being unmodifiable or modifiable, as shown in FIGS. 5A and 5B, respectively. FIGS. 5C and 5D also illustrate selected fieldsets as shown to a user in display mode and update mode, respectively, according to one embodiment of the present invention.

Request fields are used to read fields from the workspace Request table like ‘status’.

Generic Part is used to indicate to read a Generic Data type field. The fieldsource is set to ‘G’ when a Generic Data type field is configured.

Additional data may be used for additional data related to data types which are used for holding relationship data between objects in the data model, which may have data specific to the type of relation. This data may be stored in an Adata field (see Table 5 above).

Dependencies: According to one embodiment, a field can depend on another field in 2 ways: Layout based dependency (e.g., Field A should be shown next (behind) to Field B) and Logically (Values of Field A depend on value chosen for Field).

These kinds of dependencies can be configured on the field level in Dependent Type and Dependent Field.

For example, in the definition of Field A, the Dependent Type can be set and the Dependent Field is Field B. In one embodiment, the name in the Dependent Field should be the technical fieldname of Field B AND Field B should also be defined for the same fieldset.

In case a field depends on more then 1 field, a cascading principle is applied. For example, values of Field B depend may depend on values of Field A and Field A depend on values of Field C.

In one embodiment, the logical dependencies will be sent automatically the as part of the xml_in when calling the service to retrieve the values of a certain field.

Values from a dependency type table (e.g., YGLUI_DOM_WID_DEPEND_TYPE) include “X” and “B”, which may be used to respectively indicate values that should be Displayed next to other fields and Display and Value dependency.

“Displayed next to” indicates layout-based dependency. This is important in display and update mode and may be used to indicate to the user interface that the identified field should be located adjacent to a particular other field as shown, for example, in the screenshot shown in FIG. 5E.

“Only values influenced by” indicates a logical dependency. This is important in update mode when retrieving values, and may not be visible for the user in any special way.

“Display and Value” dependency applies both dependencies at once.

Service values: The name of a service can be specified in this configuration field. This is typically configured for autocompleters, selection boxes, checkboxes and radio buttons. The specified service will be called to retrieve the possible values for the defined field.

The service should at least inherit from a service template YGLUI_CLA_SERVICE_TEMPLATE like any other workspace service and should have the same public attributes like the core service value GET_FIELD_VAL and may inherit from a default service value table YGLUI_CLA_S_GET_FIELD_VAL for all service values.

The web-based user interface component automatically calls the service when needed and passes all necessary information based on the corresponding field information (like possible depending fields).

Some core service values include: GET_FIELD_VAL: The normal service to retrieve the values. Without dependency fields. GET_FIELD_VAL0: The field val with dependent fields. GET_PCR_VAL: To retrieve the data from the wizard step-0 (specific for PCR).

According to one embodiment, the Service PAI identifies the name of the service that will handle the Process After Input (PAI) on a field level. The service at least inherits from YGLUI_CLA_PAI_TEMPLATE. The service will automatically be called when a value has been chosen or inserted by the user. The user interface layer 110 may provide a web script (e.g., JavaScript®) to a web browser, where the web script will send all data (field values & field settings) related to the accessed record in order to process in the PAI service. The service will return the same structure of data but most likely with updated information.

This kind of PAI service can be used to return error or information messages to implement specific checks on fields.

In embodiments without PAI services, the web script may perform pre-checks on mandatory fields and correct date formats.

See also Fieldset Header described above.

Display attributes are part of the actual field settings used by the web script to be able to perform some web logic on the fields that are sent within the fieldset and may be defined in a display attributes table (e.g., YGLUI_DOM_WID_DISPLAY_ATT) as shown, for example, in Table 6 below:

TABLE 6
Values from display attributes table

| | |
|---|---|
| MAN | Mandatory |
| OPT | Optional |
| OUO | Output Only (Default) |
| HID | Hidden |
| HOU | Hidden Output Only |

The “Mandatory” option will show the field on the screen and is editable in update mode. The field will be marked with * to indicate it's mandatory to fill in before saving the data. If the field is not filled in on submitting the date, the field will be marked in read. Data with display attribute MAN are always sent to the request table.

The “Optional” option will show the field on the screen and is editable in update mode.

The “Output only” option will show field on the screen and is plain text both in display as in update mode. Output only fields are not sent to the request table.

The “Hidden” option causes the field to not be shown in the screen at all. Typically it's set on hidden to process later on in a PAT service. Hidden fields are not sent to the request table.

When using the “Hidden Output Only” option, the field is not shown on the screen at all and the value it might contain is processed in save_request. Is only there for internal screen logic.

According to one embodiment, the field type indicates the position of the field in the screen that is linked to the fieldset. The web script will place the field in a certain area or way depending on this field type which are defined, for example, in a field type table (e.g., YGLUI_DOM_WID_FIELDTYPE) as shown in Table 7 below.

TABLE 7
Values from field type table

| (null) | default |
|---|---|
| H | Header (List option) |
| S | secondary - Need to click on “View More” |
| G | Grouping Field (List option) |

In the Default option, the fields are shown beneath each other (taking layout dependency into account), as shown in FIG. 5F.

The “Header” setting is used when List mode is indicated on screen level. This field type indicates that certain fields should be shown as header of the list in display mode. In Update mode, each field is treated as default or secondary. In some instances, when list mode is configured and none of the fields are marked as ‘H’, the web script may not be able to process the screen for display.

In one embodiment, “Secondary” fields are hidden by default and a link to view more information (the hidden fields) is available. Clicking on the link will show the fields marked as ‘Secondary’. FIG. 5G is two screenshots illustrating the default hidden view and a link “View details . . .” for showing the secondary fields. The secondary fields are shown at the right side of FIG. 5G (e.g., “Payroll Area”, “Percentage”, and “Position)”. This behavior/view is the same for both display and update mode.

Grouping Field may be used when Table mode is indicated. In combination with the Grouping Field as Field Type, the dependent field may also be set.

FIG. 5H is a screenshot of a screen built with a fieldset in table mode and having 4 fields: Competency and Competency Group AND Status and Status Group (Bubbles), according to one embodiment of the present invention.

The Grouping Field Type is set on the ‘Competency Group’ field AND the Competency field is set as Depending Field for Competency Group. With this configuration the records with the same Competency group will be grouped as shown in FIG. 5H.

FIGS. 5I and 5J are screenshots showing the configuration of COMP_GRP and COMP fields in accordance with an embodiment of the present invention.

The Compentency Field type is set as ‘Header’ to make sure to enable it's possible to configure detail fields on ‘default level’. The label on top of the table mode is coming from the fields indicated as header list.

In this example, competency group is used as the grouping field and the grouping field can be used as the header. Others could also be used as default (this would allow clicking on group to see more details).

According to one embodiment, the sequence number determines the order of the fields within a fieldset. This order is taken into account when showing the fieldset in the user interface in display mode and update mode (as well as in list mode and table mode header and grouping fields).

The same label tag can be added for screens that should belong to the same group. On the screen, the fields will be bundled per group and some extra spacing may be placed on the user interface between the different groups. In case the label tag is translated in the label table, bold text will be visible above the group of fields.

Groups are visible in display and in update mode. FIG. 5K is a screenshot showing 3 groups (with labels). Fields “For,” “Subtype” and “From/To” are not part of a group and have a sequence number smaller than the fields from the three groups such that they are placed on the user interface before the three groups.

In case a radio button group needs to be configured, special conventions may be needed for proper display. Each field that should be part of the same radio button group should have a group called: RADIO_Gxx_y, where xx is the group identification (this allows having different radio button groups in 1 screen), and y is the identification of the field within the radio button group. Next to that an additional dummy field may be placed for each normal field within the radio button group. The name of the dummy field may have a name such as OPT_Gxx_y, through the xx and y, the dummy fields are linked to the actual fields.

One of these dummy fields may contain ‘X’ to indicate the selected value. In addition, a default method for the Option that may be flagged by default.

FIG. 5L is a screenshot illustrating an example from an Absence Maintenance interface. The web script will only save the value entered for the selected option.

The field format indicates which web script component to use in update mode and may be defined, for example, in a field format table (e.g., YGLUI_DOM_WID_FIELDFORMAT) as shown in Table 8 below:

TABLE 8
Values from field format table

| Value | Field format |
|---|---|
| P | Date picker (e.g., monthly calendar pop up) |
| D | Date field (display only) |
| A | Autocomplete |
| S | Select box |
| I | Input field |
| R | Radio button |
| C | Checkbox |
| V | Value (display only) |
| T | Text area |
| O | Part of radio button group |
| H | Hour field |
| L | Link |
| M | Picture place holder |
| B | Status Bubble |
| E | Link with handler |

In some embodiments, plain text values indicated as Output only or Hidden will not be sent to the request tables

‘E’ is a link to a handler defined by the developer.

‘L’ is to link a hyperlink stored in the value node, so, if fieldFormat=‘L’ something like “http://www.google.com” may be the value attribute of this fieldDisplayer.

Show Id/Text: Some values have both values and text. Therefore, on the field level it's possible to indicate which kind of info to retrieve and which one to display. According to one embodiment, the show id/text field may have values in accordance with a show id/text table (e.g., YGLUI_DOM_WID_SHOW_TEXT) as shown in Table 9, below.

Note: for fields using a ‘service value’ it may be mandatory to choose a show id/text-option where both value and text is sent.

TABLE 9
Values from a show id/text table

| | |
|---|---|
| X | Text only (Default) |
| B | Text + ID |
| | ID only |
| I | Text + ID (not shown) |

When show text is set to “Text+ID” the text and id value of a field are sent to the web script and will be displayed. The ID will be shown with a separator. This separator can be defined in an workspace parameter ‘99SEP’ and is set on [ ] brackets by default.

“Text+ID (not shown)” in this case the text and id value of a field is sent to the web script, but only the text will be visible for the user.

According to one embodiment of the present invention, a label can be set with the value of a field based on the label type (e.g., table YGLUI_DOM_WID_LABEL_TYPE) as listed, for example, in Table 10 below.

TABLE 10
Values from a label type table

| | |
|---|---|
| N | Not displayed |
| | From workspace label table |
| V | From Variable text |

Under the “Not displayed” setting, the label is not sent to the web script and is also not displayed.

Under the “From workspace label table” setting, the label is retrieved from the workspace label table and can be maintained in different languages via label language translation tables (e.g., YGLUI_VIE_LABEL1 and YGLUI_VIE_LABEL2).

Under the “From Variable text” setting, the label is retrieved from the long description of the domain of the field. Maintenance may be done in standard GUI text tables.

Rule id may refer to a unique identifier of a rule (control validity, e.g., modulo controls).

Mask may refer to a mask to be applied to the field (e.g., for telephone numbers, bank accounts, etc.).

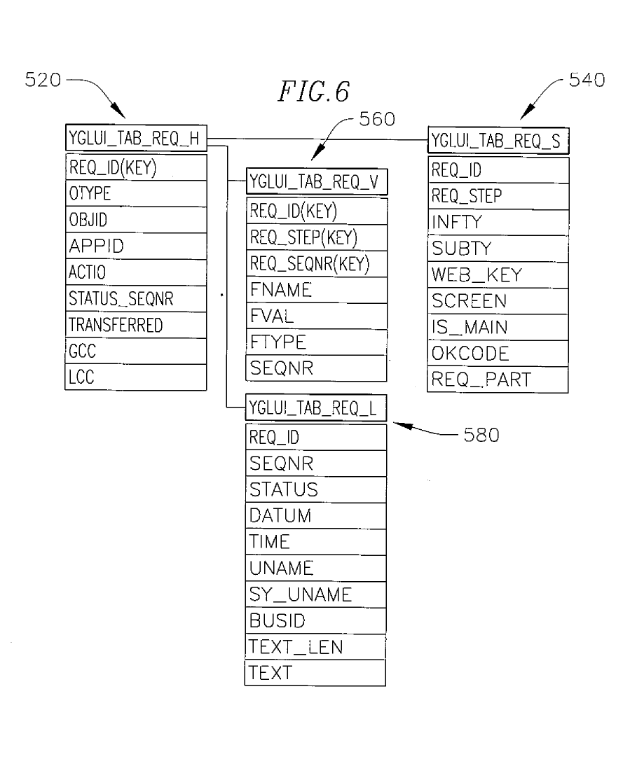

FIG. 6 is an illustration of the data model used for a request table according to one embodiment of the present invention.

FIG. 2C illustrates a Fieldset and PDC Data Model according to one embodiment of the present invention. Screen table 240 (e.g., YGLUI_TAB_DSCRN) holds the relationship between the appid, the screen, and fieldset on a per country basis. The fieldset header record 260 (e.g., YGLUI_TAB_DFS_H) is a record associated with a data object (or an data type) that holds high level data of the fieldset such as the period used to retrieve records, field set variants, and whether the data can be translated online and that includes references to one or more fieldset value records 280 (e.g., YGLUI_TAB_DFS_V), each of which is associated with (or corresponds to) a field of the data object. For example, if a fieldset header record 260 YGLUI_TAB_DFS_H record refers to an address data object, and an address data object includes a street name, a city name, a country name, and a postal code, then the fieldset header record 260 YGLUI_TAB_DFS_H corresponding to the address data object would be associated with four fieldset value records 280 YGLUI_TAB_DFS_V (one for each of the four fields of the address data object).

The screen table 240, the fieldset header record 260, and the fieldset value record 280 can be overridden or reconfigured by a user or customer in a customized screen table 242 (e.g., YGLUI_TAB_CSCRN), a customized fieldset header record 260 (e.g., YGLUI_TAB_CFS_H), and a customized fieldset value record 280 (e.g., YGLUI_TAB_CFS_V).

The configured fieldsets are used in PDC screens and in PCR screens (steps) and define how the screens look, how the fields are displayed, and how the screen behaves.

When the user 16 provides a request to save or submit a data change, the workspace stores the received information in a fieldset which is written to the request table. FIG. 6 illustrates a request table data model that utilizes fieldsets according to one embodiment of the present invention.

Upon save or submission of data in the PDC or PCR, the data supplied by the user is stored in a temporary table (referred to as the “request table” herein). The records pertaining to one data change either through a PDC (one screen data change) or PCR (Wizard driven data change) are uniquely identified by the Request ID from the request table which is the unique identifier of the saved/submitted changes. Thus, a single Request ID is associated with a specific PDC or specific PCR which in turn is associated with a single fieldset.

The request ID (REQ_ID) is the unique identifier of a request as the key in the request tables. (See FIG. 6)

As shown in FIG. 6, a request table object record 520 (YGLUI_TAB_REQ_H) is used to identify an accessed object (generally an employee, but can also be a organization unit, a position etc.) According to one embodiment, the accessed object is identified by 2 fields: OTYPE (specifies which type of object it is (e.g., P=Employee, O=Organizational unit, S=Position, C=Function, etc.) and the unique identifier OBJID, which is the id number of the object.

The request table data structure record 540 (YGLUI_TAB_REQ_S) is used to identify the data structure (or data object or data type) of the underlying working database (or human resource records) that is impacted by the different fields and steps in a request. In other words, the request which is associated with a specific fieldset may impact different data structures of the HR database, and each of those data structures are identified via a different request table data structure record 540 (YGLUI_TAB_REQ_S).

The actual field values of the fieldset are stored in the request table values record 560 (YGLUI_TAB_REQ_V), where one request table values record 560 is used for each field of the data type/data structure as described above.

In this manner, the various records associated with a request reflect a particular grouping of the fields of one or more data records where the grouping is configured to abstract a data model used by the human resource database.

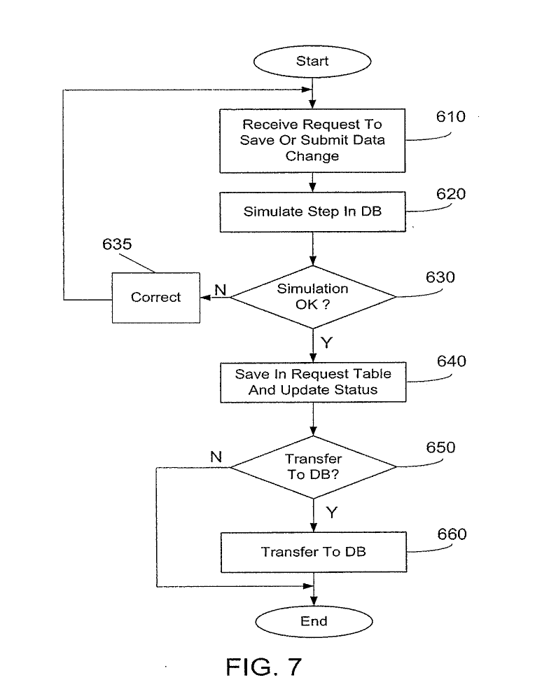

FIG. 7 is a process flow diagram illustrating a method of executing a request to save or to submit a data change affecting one or more fields of the human resource database 18 according to one embodiment of the present invention. For example, a user may request that his home address be updated. According to one embodiment, the request is associated with a fieldset (e.g. an “address” fieldset) that groups various fields of the database 18 into the single fieldset. The user may be guided to make changes to the fields of the fieldset in a user-friendly manner, such as, for example, via a wizard. The user interactions may be web-browser based and require no technical knowledge of the underlying database structure.

The process starts, and in step 610, the workspace 100 receives a request to save a data change into the request table or submit to start a workflow for approval or completion or to directly update the database, as appropriate for the status of the request. For example, an employee may request a change to his home address. The user may initiate the request by transmitting a command associated with address changes, and, during the processing of the request, the user may be prompted by the workspace to supply new values for the street name, city name, country name, and postal code. When the request containing the new values is initially received, the workspace generates a new request table object record 520 (e.g., YGLUI_TAB_REQ_H) (FIG. 6) with a unique request ID (REQ_ID). According to one embodiment, one request table data structure record 540 (e.g., YGLUI_TAB_REQ_S) is generated and associated with the change request per data type/data structure involved in the change. In this example, because only one data type/data structure (“address”) is involved in the change, only one new request table data structure record 540 (e.g., YGLUI_TAB_REQ_S) record is generated. A request table values record 560 (e.g., YGLUI_TAB_REQ_V) is then generated for each field of each associated request table data structure record 540 (e.g., YGLUI_TAB_REQ_S) record. For example, because the “address” data type includes four fields, four request table values records 560 (e.g., YGLUI_TAB_REQ_V) are generated. The workspace 100 then saves the values supplied by the user into the four request table values records 560 (e.g., YGLUI_TAB_REQ_V).

In step 620, the workspace may validate the input by simulating the addition of the new data to the working database. This simulation step may be accomplished using techniques commonly known in the space of database transaction processing, such as the PAI and PBO commands in an SAP® database system.

If the simulation indicates that the input is invalid, as determined in step 630, the workspace prompts the user to correct the action in step 635, and the process returns to step 610 to await for the corrected data. If the simulation indicates that the input is valid, then the workspace, in step 640, stores the data in the request table via the generated request table object record 520, request table data structure record 540, and request table values record 560. The workspace then updates a status associated with the request ID. The status information may be stored in a log record 580 (e.g. YGLUI_TAB_REQ_L) created for the specific request ID. The status may indicate, for example, that the submitted data has been saved; approved, completed, etc. Specifically, a log associated with the request containing the status of the request (STATUS), the username of the user changing the data (UNAME), and the userid of the user (SY-UNAME), date and time stamp of the changes and additional comments, is stored in the log record 580 (YGLUI_TAB_REQ_L).

In step 650, the workspace checks to see whether the data is to be written (or transferred) to the human resources database 18. In this regard, the workspace monitors the status field of the log record for determining whether the data associated with the request ID may be written to the database. For example, some changes to records may require approval by another party before they can be written to the database. As another example, the data may need to be added in a number of steps and may require information from multiple individuals (e.g., an employee, a supervisor, and a manager) and therefore the information may first need to be saved in the request table and opened later by another employee to add additional information. If the data is not to be written to the working database, the process ends.

If the data is to be written to the database, the workspace creates new data objects using the information stored in the request table data structure record 540 YGLUI_TAB_REQ_S and request table values record 560 YGLUI_TAB_REQ_V of the request, and the new data objects are written to the database. In this regard, the request ID and request step ID stored in the request table data structure record 540 YGLUI_TAB_REQ_S identifies the specific request table values records 560 YGLUI_TAB_REQ_V storing the necessary data. In addition, an OKCODE field stored in the request table data structure record 540 YGLUI_TAB_REQ_S specifies the type of action to be executed for the data type, such as for example, inserting, copying, deleting, and the like. In the example given above, an address object is created and the street name, city name, country name, and postal code are extracted from the identified request table values records 560 YGLUI_TAB_REQ_V and supplied to the address object construction procedure provided by the underlying database implementation, as will be apparent to a person of skill in the art.

As such, embodiments of the present invention provide an abstraction layer and a request table which provides a more logical user interface between the user and the underlying database, allows the saving of complete and incomplete draft copies of change requests without modifying the content of the working database, and allows multiple users to collaboratively create, review, edit, and approve changes entirely within the workspace and automatically write those changes to the working database when appropriate.

Although this invention has been described in certain specific embodiments, those skilled in the art will have no difficulty devising variations to the described embodiment which in no way depart from the scope and spirit of the present invention. Furthermore, to those skilled in the various arts, the invention itself herein will suggest solutions to other tasks and adaptations for other applications. It is the applicants intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A method for processing changes to a database, the method comprising:
receiving a request to alter data stored in the database, the request including data being entered in one or more steps wherein each of the steps displays one or more data fields associated with the step;
generating a plurality of records based on the received request, wherein the records reflect a particular grouping of the data fields configured to abstract a data model used by the database;
temporarily storing the plurality of records in a table;
determining whether the request should be processed to alter the data stored in the database; and
in response to the determination, modifying the data stored in the database in accordance with the plurality of records stored in the table.

2. The method of claim 1, wherein the data fields are grouped into a data set, the data fields of the data set corresponding to data fields in one or more data structures in the database.

3. The method of claim 2, wherein the generating the plurality of records includes generating a field record for each of the data fields in the data set.

4. The method of claim 3, wherein the request is identified by a request ID, and each field record includes the request ID of the corresponding request.

5. The method of claim 2, wherein the generating the plurality of records includes generating a data structure record for each of the one or more data structures in the database including a data field corresponding to the data field in the data set.

6. The method of claim 5, wherein the data structure record identifies the data structure in the database affected by the received request.

7. The method of claim 1, wherein the generating the plurality of records includes generating a log record identifying a user action with respect to the received request.

8. The method of claim 1, wherein each step displays the one or more of the data fields associated with the step, on a single screen.

9. A database system comprising:
a user interface system;
a process integration layer;
a temporary database; and
a working database, the process integration layer being configured to:
receive a request to alter data stored in the working database via the user interface system, the request including data being entered in one or more steps wherein the user interface system is configured to display, in each of the steps, one or more data fields associated with the step;
generate a plurality of records based on the received data, wherein the records reflect a particular grouping of the data fields configured to abstract a data model used by the working database;
temporarily store the plurality of records in the temporary database;
determine whether the received data should be processed to alter the data stored in the working database; and
in response to the determination, modify the data stored in the working database in accordance with the plurality of records stored in the temporary database.

10. The system of claim 9, wherein the user interface system is a web-based user interface.

11. The system of claim 9, wherein the temporary database and the working database are tables within a single database system.

12. The system of claim 9, wherein the data fields are grouped into a data set, the data fields of the data set corresponding to data fields in one or more data structures in the database.

13. The system of claim 12, wherein the data fields are grouped into a data set, the data fields of the data set corresponding to data fields in one or more data structures in the database.

14. The system of claim 13, wherein the request is identified by a request ID, and each field record includes the request ID of the corresponding request.

15. The system of claim 12, wherein the process integration layer is configured to generate the plurality of records by generating a data structure record for each of the one or more data structures in the database including a data field corresponding to the data field in the data set.

16. The system of claim 15, wherein the data structure record identifies the data structure in the affected by the received data.

17. The system of claim 9, wherein the process integration layer is configured to generate a log record identifying a user action with respect to the received data.

18. The system of claim 9, wherein the user interface is configured to display the one or more of the data fields associated with the step, on a single screen.

19. A method for managing a database system, the method comprising:
receiving a user request for effectuating a change in a working database, the working database including a plurality of data structures having a plurality of data fields, wherein the plurality of data fields are grouped into a data set linked to a user input step;
identifying the user input step based on the request;
displaying each of the data fields of the data set during the user input step for prompting input of data associated with one or more of the data fields;
generating a plurality of records based on the data input during the input step;
temporarily storing the plurality of records in a table;
determining whether the change in the working database should be effectuated; and
in response to the determination, effectuating the change in the working database in accordance with the plurality of records stored in the table.

20. The method of claim 19, wherein the data fields of the data set are displayed during the user input step on a single screen.
